(19) United States
(12) Patent Application Publication
(10) Pub. No.: US 2014/0032680 A1
(43) Pub. Date: Jan. 30, 2014

(54) Multimedia mail system

(71) Applicant: Srikanth Palli, Mylapore (IN)

(72) Inventor: Srikanth Palli, Mylapore (IN)

(73) Assignee: Adobe Systems Incorporated

(21) Appl. No.: 11/499,183

(22) Filed: Aug. 3, 2006

(51) Int. Cl. H04L 12/58

(52) U.S. Cl. CPC H04L 51/10
USPC 709/206

(57) ABSTRACT

There is provided a method and a system to initiate streaming of a multimedia content message. The system includes a receiving module to receive a stream that includes a multimedia content message and a recipient list that includes a first recipient. Further the system includes a multimedia module to store the stream in a multimedia content file, the multimedia module to generate a multimedia retrieval message that includes a stream identifier that identifies the stream, the multimedia module to communicate the multimedia retrieval message, over a network, to the first recipient, the multimedia retrieval message to enable a selection of the stream identifier to initiate the stream of the multimedia content file, over the network, to the first recipient.

### FIELD

This application relates to data communications and, in one example embodiment, to methods and systems to initiate streaming of a multimedia content message.

### BACKGROUND

A user that sends a multimedia content file that contains audio data and video data over a network may encounter problems. One problem may be that the multimedia content file is not delivered because of its size. For example, the user may compose the multimedia content file at a client machine, attach the multimedia content file to an email, and send the email, with the attached multimedia content file, to a recipient client machine. However, the recipient client machine may not receive the multimedia content file because the recipient's inbox may impose a size limitation that prevents processing the attachment. Another problem may be that the software that generates the multimedia content file may require the client machine to provide substantial storage capacity (e.g., memory) and processing power. Consequently, some client machines may not be able to generate a multimedia content file because they lack sufficient memory and processing power.

### BRIEF DESCRIPTION OF DRAWINGS

The present invention is illustrated by way of example and not limitation in the figures of the accompanying drawings, in which like references indicate similar elements and in which:

FIG. 1 is a block diagram of a system used in an example embodiment of the present disclosure;

FIG. 2 is a block diagram of a client machine used in an example embodiment of the present disclosure;

FIG. 3 is a block diagram of a client machine used in an example embodiment of the present disclosure;

FIG. 4 is a block diagram of a multimedia content message used in an example embodiment of the present disclosure;

FIG. 5 is a block diagram of a multimedia metadata message used in an example embodiment of the present disclosure;

FIG. 6 is a block diagram of a recipient list used in an example embodiment of the present disclosure;

FIG. 7 is a block diagram of a multimedia table used in an example embodiment of the present disclosure;

FIG. 8 is a block diagram of a multimedia retrieval message used in an example embodiment of the present disclosure;

FIG. 9 is a block diagram of a multimedia content message identifier used in an example embodiment of the present disclosure;

FIG. 10 is a flow chart of a method used in an example embodiment of the present disclosure;

FIG. 11-14 are representations of user interfaces used in an example embodiment of the present disclosure;

FIG. 15 is a block diagram of a machine, according to an example embodiment, including instructions to perform any one or more of the methodologies described herein.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

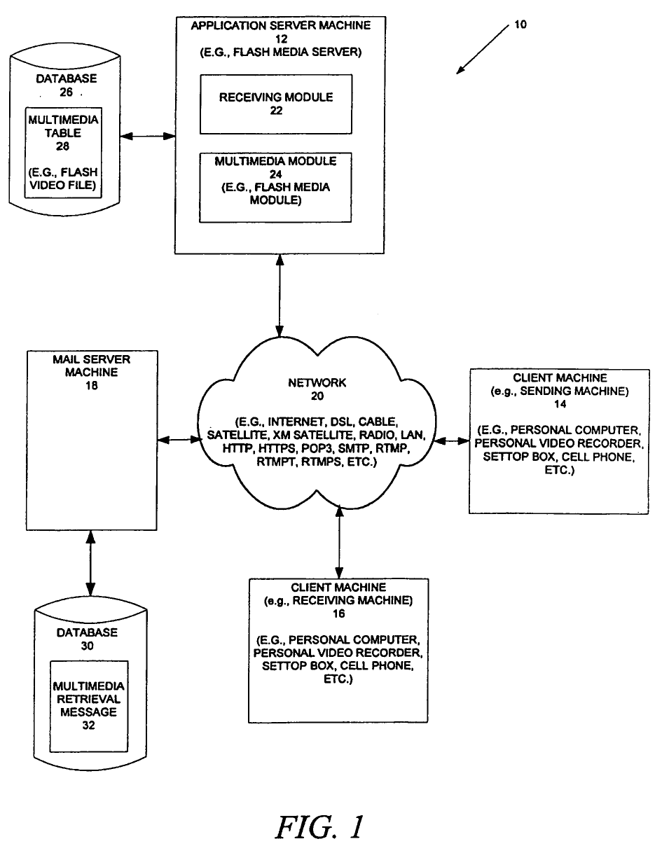

FIG. 1 is a block diagram of a system 10 used in an example embodiment of the present disclosure. The system 10 is shown to include an application server machine 12 (e.g., Flash® media server), a client machine 14 (e.g., sending machine), a client machine 16 (e.g., receiving machine), and a mail server machine 18 that communicate over a network 20.

The client machine 14, in the present embodiment, may be a sending machine that is utilized to send multimedia mail and/or email (e.g., electronic messages) and may be embodied as a personal computer, a personal video recorder, a set top box, a cell phone, or any other device capable of sending and receiving email and streaming multimedia. For example, the client machine 14 may include a microphone and camera that may be utilized by a user to stream a multimedia content message that includes audio data and video data over the network 20 to the application server machine 12. Multimedia content is defined as content that includes two or more media (e.g., text, audio, graphics, animation, video, etc.).

In one example embodiment, the client machine 14 may use the Real Time Messaging Protocol (RTMP) to stream the multimedia content message from the client machine 14 to the application server machine 12. The RTMP is a proprietary protocol by Adobe Systems Inc. of San Jose, Calif. used for accessing streaming multimedia and for elementary remote function calls. Other embodiments may use the RTMPT or the RTMPS protocols that use tunneling via the HTTP and HTTPS protocols respectively. Further the client machine 14 may be utilized by the user to communicate a recipient list that may identify the recipients of the multimedia content message and a multimedia metadata message (e.g., including XML content) that may include metadata for the multimedia content message. For example, in one example embodiment the client machine 14 may utilize the Simple Mail Transfer Protocol (SMTP) to commuincate the recipient list and the multimedia metadata message.

The application server machine 12 is shown to include a receiving module 22 and a multimedia module 24 and is coupled to a database 26. The receiving module 22 may receive the streamed multimedia content message, the recipient list and the multimedia metadata message. Further, the receiving module 22 may store the multimedia content message as a multimedia content file (e.g., Flash® video file) in a multimedia table 28 in the database 26 and the multimedia metadata message in the multimedia table 28 in the database 26. Further, the multimedia module 24 may generate a multimedia retrieval message(s) based on the recipient list and communicate the multimedia retrieval message(s) over the network 20 to the mail server machine(s) 18 identified by the recipient list. The multimedia retrieval message may include a multimedia message identifier that is utilized to identify the location of the Flash® video file. Further, the multimedia retrieval message may be compliant with the Multipurpose Internet Mail Extension (MIME), an Internet standard specifying message formats for transmission of different types of data by electronic mail.

The mail server machine 18 is shown to be coupled to a database 30 that may be used to store multimedia retrieval messages 32 and email messages (e.g., electronic messages) in the database 30. The mail server machine 18 may respond to requests from the client machine 16 to retrieve multimedia retrieval messages and email messages.

The client machine 16, in the example embodiment, may be a receiving machine to receive a multimedia mail and may be embodied as the client machine 14 described above. The client machine 16 may be utilized by a user to receive the multimedia mail. For example, the user may retrieve the multimedia retrieval message and/or email (e.g., electronic messages) from the mail server machine 18 and select a multimedia retrieval message to initiate streaming. In one example embodiment, the client machine 16 may use the Plain Old Post Office Version 3 (POP3) protocol to retrieve the multimedia retrieval message and or email from the mail server machine 18. The POP3 protocol is an application-layer Internet standard protocol to retrieve e-mail from a remote server over a TCP/IP connection. Accordingly, the user may select the multimedia retrieval message to cause the client machine 16 to utilize the associated multimedia content message identifier to initiate streaming of the multimedia content message, over the network 20 (e.g., RTMP, RTMPT, RTMPS), for play on the client machine 16.

The network 20 may be any network capable of communicating text and/or video and/or audio and/or graphics, and/or animation, etc., and may include the Internet, Digital Subscriber Line (DSL), satellite, cable, digital, terrestrial, XM satellite, Local Area Networks (LAN), radio, etc. It will be appreciated that while the client machine 14 is described above as sending the multimedia mail and the client machine 16 is described above as receiving the multimedia mail that such a description is merely for the purpose of clarity and that the client machines 14, 16 may both send and receive the multimedia mail. Further, while the system 10 is shown in FIG. 1 to employ a client-server architecture, the present disclosure is of course not limited to such an architecture, and could equally well find application in other architectures. Embodiments may, for example, be implemented as a standalone application (e.g., without any network capabilities), a client-server application or a peer-to-peer (or distributed) application. Embodiments may, for example, be deployed by Software as a Service (SaaS), Application Service Provider (ASP), or utility computing providers, in addition to being sold or licensed via traditional channels.

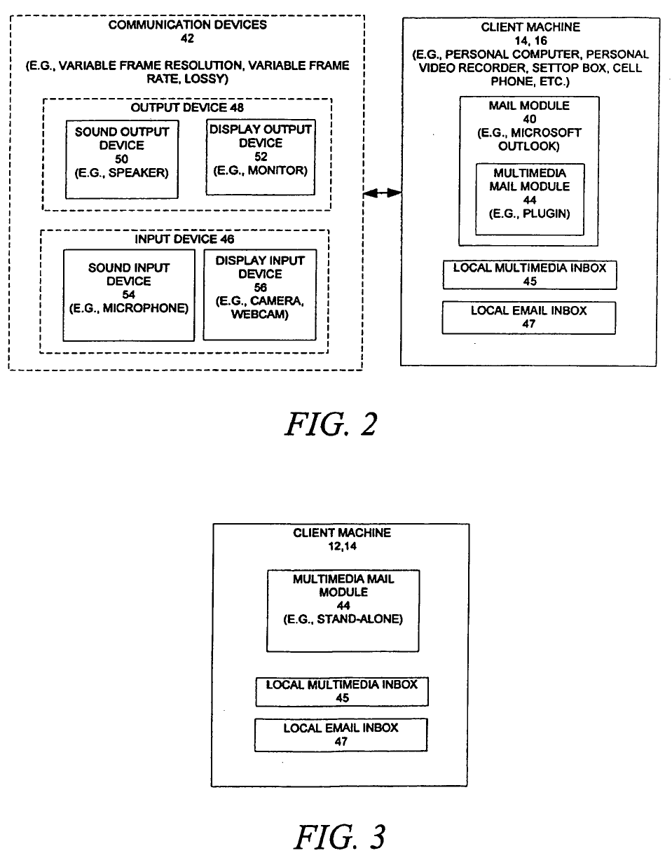

FIG. 2 is a block diagram of the client machine 14, 16 that may be used in an example embodiment of the present disclosure. The client machine 14, 16 is shown to include a mail module 40, a local multimedia inbox 45, a local email inbox 47 and shown to be coupled to communication devices 42. In one example embodiment, the mail module 40 may be embodied as Microsoft Outlook created by Microsoft Inc. of Redmond, Wash. State and may be utilized to generate and retrieve email. The mail module 40 is further shown to include a multimedia mail module 44 that, in one example embodiment, may be a plugin to the mail module 40. In general, a plugin (or plug-in) is a computer program that interacts with a main application (a web browser or an email program, for example) to provide a certain, usually very specific, function. The multimedia mail module 44 may be utilized to provide multimedia mail services by enabling the publication of a recorded media stream to the application server machine 12 and by enabling the reception of a media stream from the application server machine 12 that may be played by the multimedia mail module 44. The multimedia mail services may further include communicating a multimedia metadata message to the application server machine 12, communicating a recipient list to the application server machine 12, retrieving a multimedia retrieval message, and enabling the initiation of streaming of the multimedia content message from the application server machine 12 to the client machine 14, 16. Accordingly, the mail module 40 and the multimedia mail module 44 may be utilized to generate and retrieve email and multimedia mail. Further, the multimedia mail module 44 may be said to be a thin client rather than a thick client. For example, a thin client may include logic necessary to connect to the application server machine 12 and publish a recorded media stream to the application server machine 12. In contrast, a thick client may require logic to sufficient generate a multimedia (e.g., Adobe Flash® Video) file at the client machine 14. Also, for example, a thin client may include logic to connect to the application server machine 12, receive a media stream from the application server machine 12, and play the media stream at the client machine 16. A thick client may require downloading the entire multimedia (e.g., Flash® file) from the application server machine 12 before playing the multimedia file at the receiving machine (e.g., client machine 16). The local multimedia inbox 45 may be utilized to store multimedia retrieval messages that may be retrieved by the receiving machine (e.g., client machine 16) from the mail server machine 18. The local email inbox 47 may be utilized to store email messages that may be retrieved by the receiving machine (e.g., client machine 16) from the mail server machine 18.

The communication devices 42 are shown to include input devices 46 and output devices 48. The input devices 46 may include a sound input device 54 for recording audio data and a display input device 56 for recording video data. The output devices 48 may include a sound output device 50 for presenting audio data and a display output device 52 for presenting video data; however, it will be appreciated by those skilled in the art that the output devices 48 may also include a machine device to communicate machine interface information (e.g., SGML) to a machine (e.g., client, server, peer to peer). The sound input device 54 may be embodied as a microphone and the display input device 56 may be embodied as a camera or a web cam. The sound output device 50 may be embodied as a speaker or headphones and the display output device 52 may be embodied as a monitor, a television screen, etc . . . . The communication devices 42 may be utilized to transmit and receive video and audio data by utilizing various technologies supported by the client machine 14, 16 including lossy compression, variable frame resolution and variable frame rates.

FIG. 3 is a block diagram of a client machine 14, 16 used in an example embodiment of the present disclosure. The client machine 14, 16 is shown to include the multimedia mail module 44 embodied as a stand-alone version and not a plug in. For example, the multimedia mail module 44 may provide email services in addition to the previously described multimedia (e.g., Flash Video®) services.

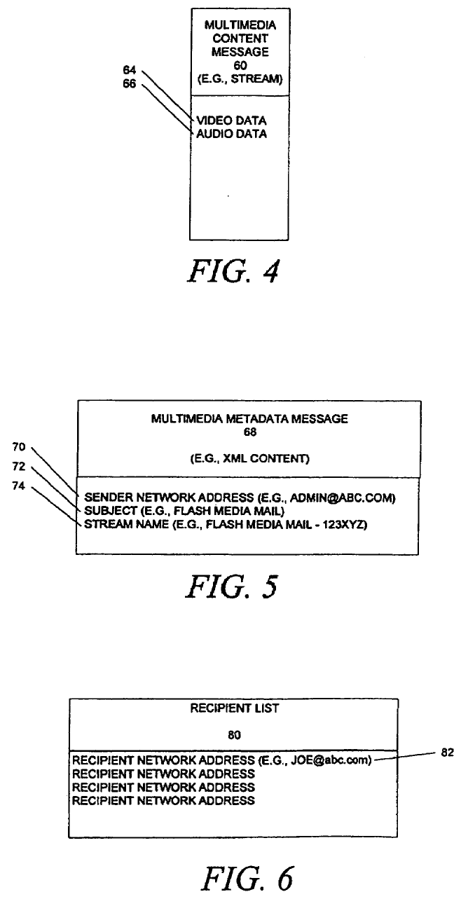

FIG. 4 is a block diagram of a multimedia content message 60 used in an example embodiment of the present disclosure. The multimedia content message 60, for example, may be streamed from a sending machine (e.g., client machine 14) to the application server machine 12 and/or from the application server machine 12 to a receiving machine (e.g., client machine 16). The multimedia content message 60 is shown to include video data 64, and audio data 66. Other embodiments of the multimedia content message 60 may include video data 64 and/or audio data 66 and/or graphic data and/or text data and/or alphanumeric data and/or still image data, etc.

FIG. 5 is a block diagram of a multimedia metadata message 68 used in an example embodiment of the present disclosure. The multimedia metadata message 68 is shown to include a sender network address 70 that may be utilized to identify the sending machine, a subject 72 and a stream name 74 that may be utilized to identify the associated multimedia content message 60. The sender network address 70 may be automatically entered into the multimedia metadata message 68 by the multimedia mail module 44 responsive to the user composing multimedia mail. The subject 72 may be entered by the user (e.g., sender) operating a keyboard at the client machine 14. In one example embodiment, the stream name 74 may be automatically generated by the multimedia mail module 44. In another embodiment, the stream name 74 may automatically generated by the multimedia module 24 at the application server machine 12. Yet in another embodiment, the stream name 74 may entered by the user (e.g., sender) operating a keyboard at the client machine 14. In one embodiment the sender network address 70 the subject 72 and the stream name 74 may be described by using Extensible Markup Language (XML). XML is a W3C-recommended general-purpose markup language for creating special-purpose markup languages and is used to describe data and the meaning of such data.

FIG. 6 is a block diagram of a recipient list 80 used in an example embodiment of the present disclosure. The recipient list 80 is shown to include multiple recipient network addresses 82 including a first recipient. The recipient network addresses 82 may be used to identify the network address of the recipients of a corresponding multimedia mail. The recipient list 80 may be entered by the user at the sending machine (e.g., client machine 14) and communicated over the network 20 to the application server machine 12. The recipient list 80 may be used by the application server machine 12 to generate multimedia retrieval messages that are communicated to the mail server machines 18 from which the receiving machines (e.g., client machine 16) may respectively retrieve the multimedia retrieval messages.

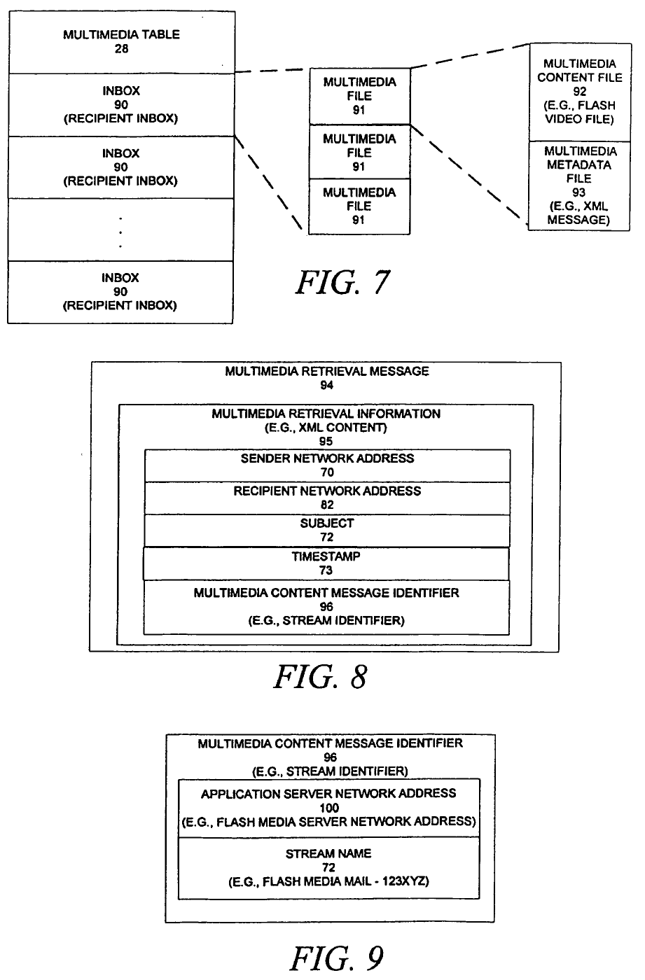

FIG. 7 is a block diagram of a multimedia table 28 used in an example embodiment of the present disclosure. The multimedia table 28 may be stored within the database 26 that may be coupled to the application server machine 12 and is shown to include multiple inboxes 90. For example, respective inboxes 90 may correspond to the recipient network addresses 82 previously described. Each inbox 90 may include one or more multimedia files 91 that respectively include the multimedia content file 92, and the multimedia metadata file 93. The multimedia content file 92 may be generated and stored in the multimedia file 91 by the receiving module 22, responsive to receipt of the multimedia content message 60 and containing the multimedia content message 60 (e.g., the multimedia content file 92 may include video data 64 and/or audio data 66 and/or graphic data). The multimedia metadata file 93 may be generated and stored in the multimedia file 91 by the receiving module 22 responsive to receipt of the multimedia metadata message 68. For example, the multimedia metadata file 93 may contain the multimedia metadata message 68.

FIG. 8 is a block diagram of a multimedia retrieval message 94 used in an example embodiment of the present disclosure. The multimedia retrieval message 94 may be generated by the application server machine 12 responsive to receipt of the multimedia metadata message 68 and/or the recipient list 80, and communicated to the mail server machine 18 where it may be retrieved by the receiving machine (e.g., client machine 16). The multimedia retrieval message 94 may be displayed on and selected from a user interface by a user operating the receiving machine (e.g., client machine 16) to initiate streaming of the corresponding multimedia content message 60 to the receiving machine (e.g., client machine 16). The multimedia retrieval message 94 is shown to include multimedia retrieval information 94 that may, for example, be described with XML. The multimedia retrieval information 94 includes the sender network address 70, the recipient network address 82, the subject 72, a timestamp 73 and a multimedia content message identifier 96. The multimedia retrieval message 94 may be generated for and communicated to a recipient network address 82 included in the recipient list 80. Multiple recipient network addresses 82 in the recipient list 80 may result in the application server machine 12 generating and communicating multiple multimedia retrieval messages 94. The multimedia retrieval message 94 may be displayed at the receiving machine (e.g., client machine 16) where the user may select the multimedia retrieval message 94 to cause the receiving machine (e.g., client machine 16) to request the application server machine 12 to initiate streaming of the multimedia content message 60 from the application server machine 12 to the receiving machine (e.g., client machine 16). For example, the receiving machine may utilize the multimedia content message identifier 96 included in the multimedia retrieval message 94 to identify the location of the application server machine 12 on the network 20 and the corresponding multimedia content file 92 on the database 26 coupled to the application server machine 12.

FIG. 9 is a block diagram of a multimedia content message identifier 96 (e.g., stream identifier) used in an example embodiment of the present disclosure. The multimedia content message identifier 96 is shown to include an application server network address 100 and the previously described stream name 74. The application server network address 100 may for example include the network address of the application server machine 12 (e.g., multimedia server) on the network 20. The stream name 74 may be communicated to and utilized by the application server machine 12 to identify the appropriate multimedia content file 92 in the database 26 and to initiate streaming of the multimedia content message 60 contained by the multimedia content file 92.

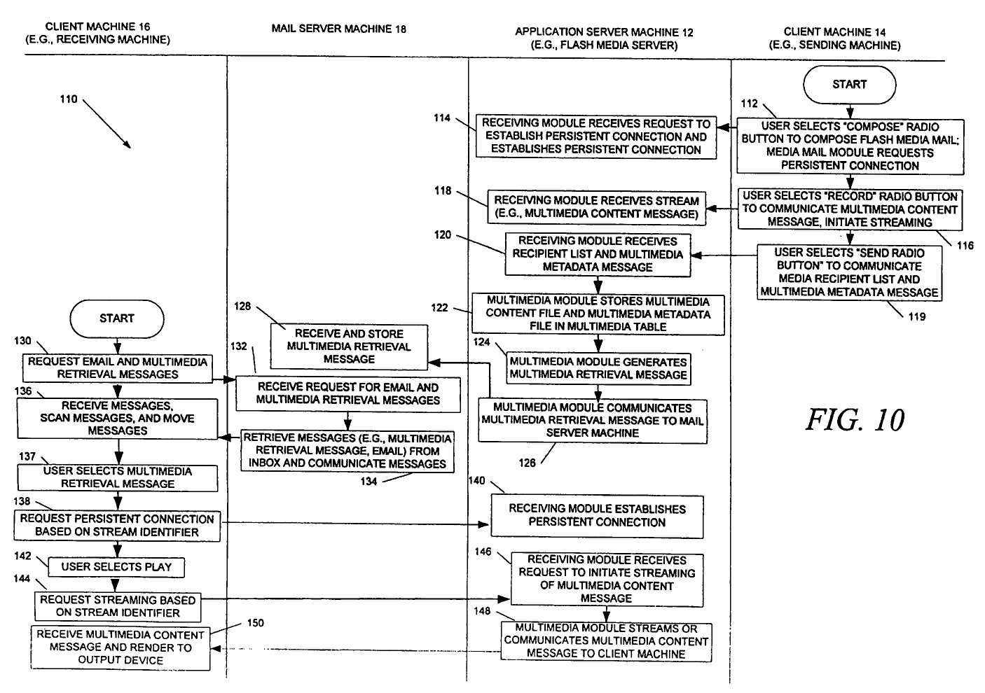

FIG. 10 is a flow chart of a method 110, used in an example embodiment of the present disclosure. Illustrated on the right is the client machine 14 (e.g., sending machine) and illustrated on the left is the client machine 16 (e.g., receiving machine). Illustrated on the center right is the application server machine 12 and illustrated on the center left is the mail server machine 18. The method 110 commences at operation 112 with the user, at the client machine 14, selecting a compose button from a user interface to initiate composition a multimedia mail. In response, the multimedia mail module 44 may request the application server machine 12 to establish a persistent connection between the client machine 14 and the application server machine 12 and display a user interface at the client machine 14 that enables the user to compose the multimedia mail.

At operation 114, at the application server machine 12, the receiving module 22 receives the request and establishes the persistent connection.

At operation 116, at the client machine 14, the user selects a record button from the user interface to initiate communicating or streaming of the multimedia content message 60. For example, the client machine 14 may utilize the sound input device 54 to record audio data that may be streamed over the persistent connection to the application server machine 12 and the display input device 56 to record video data 64 that may be streamed over the persistent connection to the application server machine 12. The user may complete the communicating or streaming of the multimedia content message 60 by selecting a stop button on the user interface.

At operation 118, at the application server machine 12, the receiving module 22 receives the multimedia content message 60 that may include the audio and video data. For example, the receiving module 22 may receive the streamed audio and video data.

At operation 119, at the client machine 14, the user enters the subject 72 of the multimedia mail into an input box on a user interface and recipient network addresses 82 into an input box on a user interface. Next, the user may to cause the client machine 14 to generate a multimedia metadata message 69 and a recipient list 80 and to communicate the multimedia metadata message 69 and the recipient list 80 to the application server machine 12 (e.g., by selecting a send button on the user interface).

At operation 120, at the application server machine 12, the receiving module 22 receives the recipient list 80 and the multimedia metadata message 68.

At operation 122, the multimedia module 24 stores the multimedia file 91 in the multimedia table 28. For example, the multimedia module 24 may store the multimedia content message 60 (e.g., stream) as the multimedia content file 92 in the multimedia table 28 and the multimedia metadata message 68 as the multimedia metadata file 93 in the multimedia table 28. The multimedia module 24 may store the multimedia file 91 in an inbox 90 in the multimedia table 28 that corresponds to a recipient network address 82 in the recipient list 80. The multimedia module 24 may store multiple copies of the multimedia file 91 in multiple corresponding inboxes 90 based on multiple recipient network addresses 82 in the recipient list.

At operation 124, the multimedia module 24 generates a multimedia retrieval message 94 that respectively include multimedia retrieval information 95 (e.g., XML content) for each recipient network address 82 in the recipient list 80. Each of the multimedia retrieval messages 94 includes a multimedia message identifier (e.g., stream identifier). Further, in one embodiment, the multimedia module 24 may generate and insert the timestamp 73 into the multimedia retrieval message 94.

At operation 126, the multimedia module 24 communicates the multimedia retrieval messages 94 to a mailbox that may be identified with the recipient network address 82. For example, the recipient network address 82 may identify a mail server machine 18 on the network 20 and a specific mailbox on the mail server machine 18 that may be used to temporarily store a multimedia retrieval message 94 for a receiving machine (e.g., client machines 16). It will further be appreciated that the mailbox at the mail server machine 18 may also be utilized to store an email for the same receiving machine (e.g., client machine 16).

At operation 128, the mail server machine 18 receives and stores the multimedia retrieval message 94 in a mailbox corresponding to the identified recipient network address 82 in the multimedia retrieval message 94.

At operation 130, the receiving machine (e.g., client machine 16) communicates a request to retrieve email and multimedia retrieval messages 94 from the mail server machine 18. For example, in one example embodiment, the client machine 16 may utilize the POP3 protocol to request the email and the multimedia retrieval messages 94 from the appropriate mailbox at mail server machine 18.

At operation 132, the mail server machine 18 may receive the request to retrieve email and multimedia retrieval messages 94 from the receiving machine. For example, the user operating the receiving machine (e.g., client machine 16) may retrieve email and multimedia retrieval messages 94 that may be addressed to the user. In one example embodiment the user may identify his or herself to the multimedia mail module 44 by providing a user name and password to the multimedia mail module 44 that may restrict access to email and multimedia retrieval messages 94 addressed to the user corresponding to the user name and password.

At operation 134, the mail server machine 18 may communicate the email and the multimedia retrieval messages 94 to the receiving machine (e.g., client machine 16) based on the request to retrieve email and multimedia retrieval messages 94.

At operation 136, the client machine 16 may receive the messages, scan the messages and move the messages. For example, the client machine 16 may receive the email and multimedia retrieval messages 94 from the mail server machine 18, scans the email and multimedia retrieval messages 94, and move the email to the local email inbox 47 and the multimedia retrieval messages 94 to local multimedia inbox 45. In one embodiment, the multimedia mail module 44 (e.g., standalone and plug-in version) may be utilized, for example, to process the multimedia retrieval information 95 (e.g., XML content) in the multimedia retrieval message 94.

At operation 137, at the client machine 16, the user operating the client machine 16 may examine the incoming email and the incoming multimedia retrieval messages 94. For example, the user may utilize a user interface to display the multimedia retrieval messages 94. In addition, the user may select a particular multimedia retrieval message 94 from the user interface.

At operation 138, the client machine 16 may respond to the selection of the particular multimedia retrieval message 94 by utilizing the multimedia content message identifier 96 included in the selected multimedia retrieval message 94 to identify the appropriate application server machine 12 and to request the application server machine 12 to establish a persistent connection between the application server machine 12 and the client machine 16. For example, the client machine 16 may identify the appropriate application server machine 12 on the network 20 based on the application server network address 100 in the multimedia content message identifier 96 in the multimedia retrieval message 94. In addition, the client machine 16 may respond to the selection of the particular multimedia retrieval message by displaying a user interface on the display output device 52 that may enable the user to play the associated multimedia content message 60.

At operation 140, the application server machine 12 may receive the request to establish a persistent connection and accordingly establish a persistent connection between the receiving machine (e.g., client machine 16) and the application server machine 12.

At operation 142, the user may initiate streaming of the multimedia content message 60 (e.g., for example by selecting a play button).

At operation 144, the multimedia mail module 44 may request streaming of the multimedia content message 60 from the application server machine 12. For example, the multimedia mail module 44 may communicate the stream name 74 in the multimedia content message identifier 96 in the multimedia retrieval message 94 to the identified application server machine 12.

At operation 146, at the application server machine 12, the receiving module 22 may receive the request to initiate streaming of the identified multimedia content file 92. For example, the multimedia content file 92 may be identified based on the received stream name 74.

At operation 148, the multimedia module 24 at the application server machine 12 reads the multimedia content file 92 corresponding to the received stream name 74 and streams or communicates the multimedia content message 60 based on the contents of the multimedia content file 92.

At operation 150, the receiving machine (e.g., client machine 16), receives the multimedia content message 60 and plays (or otherwise presents) the multimedia content message 60 on the output device 48. For example, the client machine 16 may receive the stream of the multimedia content message 60 and play out the stream on the sound output device 50 and the display output device 52.

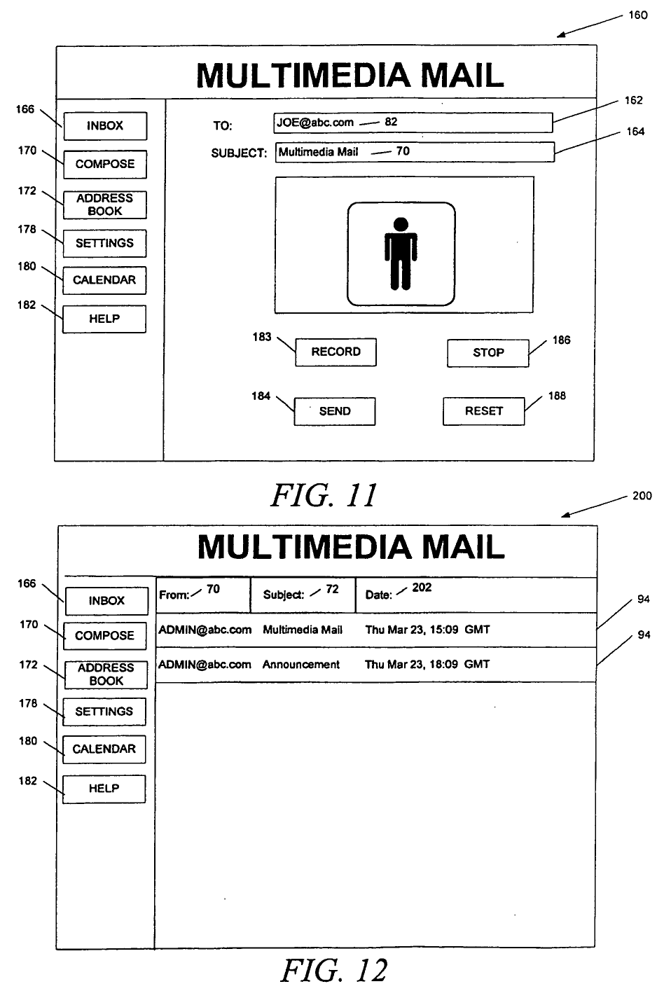

FIG. 11 is a representation of a user interface 160 used in an example embodiment of the present disclosure, to compose multimedia mail. The user interface 160 may be utilized by the plug-in version of the multimedia mail module 44 and is shown to include an input boxes 162, 164, an inbox button 166, a compose button 170, an address book button 172, a settings button 178, a calendar button 180, a help button 182, a record button 183, a send button 184, a stop button 186 and a reset button 188. The user interface 160 may be displayed on the display output device 52 in response to selection of the compose button 170.

The input box 162 may be utilized by the user to enter one or more recipient network addresses 82. For example, the input box 162 is shown to contain an example recipient network address 82 “joegabc.com” that may have been entered by the user. The input box 164 may be used by the user to enter the subject of a multimedia mail. For example, the input box 164 is shown to contain a subject “Multimedia Mail” that may have been entered by the user.

The inbox box button 166 may be selected to display a user interface on the display output device 52 that presents multimedia mail (e.g., multimedia retrieval message 94) and email that have been retrieved by the client machine 16 from the mail server machine 18. The compose button 170 may be selected to display a user interface to compose a multimedia mail. In addition, selection of the compose button 170 may cause the client machine 14 to request the application server machine 12 to establish a persistent connection between the client machine 14 and the application server machine 12. The persistent connection may be utilized by the client machine 14 to stream video data 64 and audio data 66 to the application server machine 12. The address book button 172 may be selected to display a user interface that presents names, addresses, telephone numbers, fax numbers and email addresses for users and organizations. The settings button 178 may be utilized to display a user interface to configure multimedia mail parameters utilized by the multimedia mail module 44. For example, the user interface may enable configuration of multimedia mail parameters including host names that communicate with the multimedia mail module 44, port numbers, communication protocols, etc. The calendar button 180 may be utilized to display a user interface that may enable viewing and configuring a calendar. The help button 182 may be utilized to retrieve help information regarding the multimedia mail feature.

The record button 183 may be utilized to start communicating or streaming the multimedia content message 60 that may include the video data 64 and the audio data 66. For example, the multimedia content message 60 may be communicated or streamed from the input device 46 at the client machine 14 to the application server machine 12. The stop button 186 may be utilized to stop streaming or communicating the multimedia content message 60. The reset button 188 may be utilized to restart streaming or communication of the multimedia content message 60 to the application server machine 12 thereby causing deletion of the previously communicated or streamed multimedia content message 60 at the application server machine 12. The send button 184 may be utilized to communicate the recipient list 80 and the multimedia metadata message 68 from the client machine 14 to the application server machine 12 thereby triggering the application server machine 12 to generate and communicate multimedia retrieval messages for each named recipient network addresses 82 in the recipient list 80.

Another embodiment of the above described user interface 160 may be utilized by the stand-alone version of the multimedia mail module 44. The stand-alone version of the user interface 160 may further include an outbox button that may be utilized to display multimedia mail and email that have not yet been communicated from the client machine 16 to the application server machine 12 and an outbox send button that may be utilized to communicate the recipient lists 80, corresponding multimedia metadata message 68, and emails that may be in the outbox of the client machine 14. Further, the compose button 170 may operate differently from the plug-in version by further requesting the user to specify whether the user intends to compose email or multimedia mail.

FIG. 12 is a representation of a user interface 200 using an example embodiment of the present disclosure, to display multimedia retrieval messages. The user interface 200 is shown to display multiple multimedia retrieval messages 94 that may have been retrieved from the mail server machine 18 by the receiving machine (e.g., client machine 14) and stored in the local multimedia inbox 45. Each multimedia retrieval messages 94 is shown to include a sender network address 70, a subject 72, and a date 202. In one example embodiment, the date 202 may be the date on which the multimedia content message 60 may have been streamed or communicated to application serve machine 12. The user at the receiving machine (e.g., client machine) may select a specific multimedia retrieval message 94 (e.g., Subject: Multimedia Mail) from the user interface 200 to cause the client machine 14 to request the appropriate application server machine 12 to establish a persistent connection between the receiving machine (e.g., client machine 16) and the application server machine 12 in preparation of streaming or communicating the corresponding multimedia content message 60 to the receiving machine. In addition, selection of the specific multimedia retrieval message 94 may result in displaying a user interface on the display output device 52 at the receiving machine (e.g., client machine 16) that may be utilized by the user to play the flash media mail (e.g., multimedia content message 60) associated with the selected multimedia retrieval message 94.

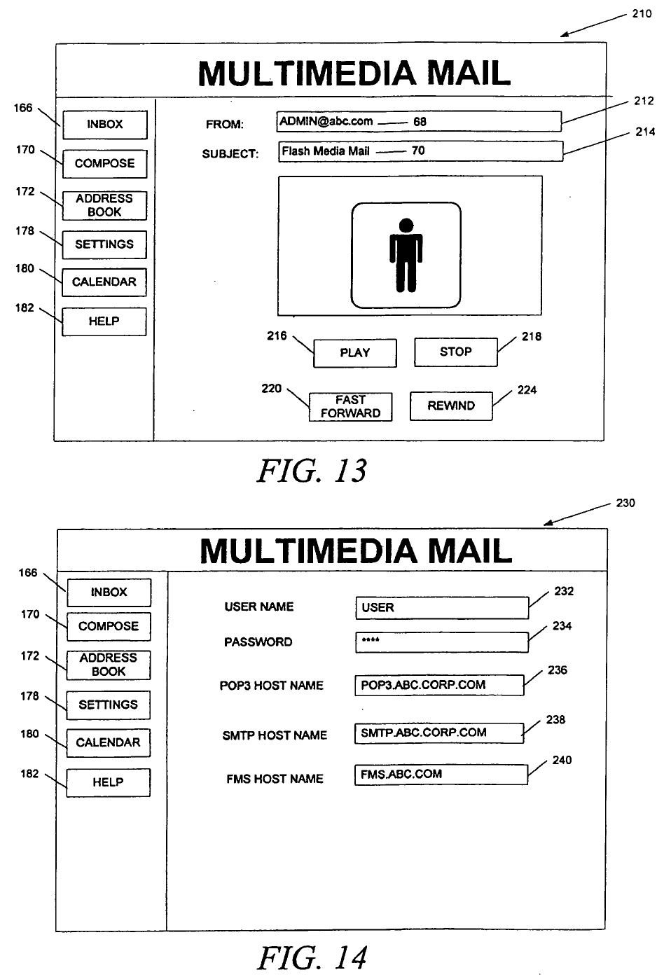

FIG. 13 is a representation of a user interface 210 used in an example embodiment of the present disclosure, to play a multimedia mail (e.g., multimedia content file 92). The user interface 210 is shown to include a “From” line 212, a “Subject:” line 214, a play button 216, a stop button 218, a fast forward button 220 and a rewind button 224. The “From:” line 212 may be used to display the sender network address 70. For example, the sender network address 70 may include the network address of the sending machine (e.g., client machine 14). The “Subject:” line 214 may include the subject 72 as input by the user operating the sending machine (e.g., client machine 14). The play button 216 may be utilized by the user operating the client machine 16 to play the multimedia mail. For example, in response to selection of the play button 216, the receiving machine (e.g., client machine 16) may request the appropriate application server machine 12 to begin streaming or communicating the multimedia content file 92 to the output devices 48 including the sound output device 50 and the display output device 52. The stop button 218 may be utilized by the user to stop playing the multimedia content file 92. The fast forward button 220 may be utilized by the user to request the application server machine 12 to fast forward the multimedia content file 92 and the rewind button 224 may be utilized by the user to request the application server machine 12 to rewind the multimedia mail.

FIG. 14 is a representation of a user interface 230 used in an example embodiment of the present disclosure, to configure multimedia mail parameters. The user interface 230 is shown to include input boxes 232, 234, 236, 238, and 240. The input box 232 may be used by the user to enter a user name and the input box 234 may be used by the user to enter a password. The multimedia mail module 44 may restrict access to the multimedia mail feature including multimedia mail unless a user provides the entered user name and password. The input box 236 may be used to enter the POP3 host name. For example, the user may enter the name of the network address of the mail server machine 18. The input box 238 may be used enter the SMTP host name. For example, in the present embodiment, the user may enter the name of the mail server machine 18. The input box 240 may be used by the user to identify the multimedia server. For example, in the present embodiment, the user may enter the name of the application server machine 12.

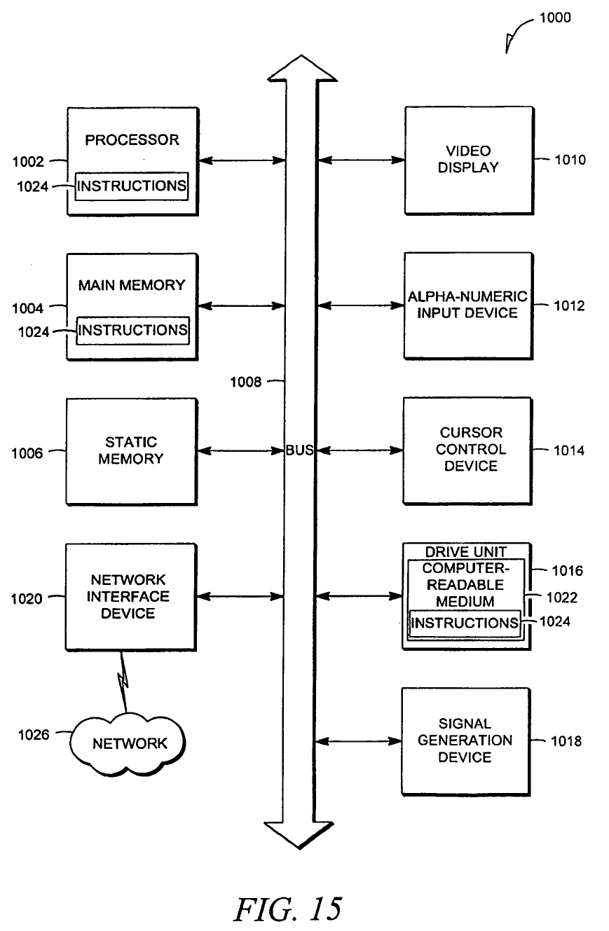

FIG. 15 shows a diagrammatic representation of machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a recipient in server-recipient network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse or cursor control device), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a receiving module to receive a stream that includes a multimedia content message and a recipient list including a recipient email address identifying a first recipient; and
a multimedia module:
to store the stream in a multimedia content file,
to generate a multimedia retrieval email message that includes a stream identifier that identifies the stream, and
to communicate the multimedia retrieval email message, over a network, to the email address of the first recipient, the stream identifier of the multimedia retrieval email message being selectable to enable streaming of the multimedia content message, over the network, to the first recipient;
wherein the receiving module and the multimedia module are implemented with one or more processor-based machines.

2. (canceled)

3. The system of claim 1, wherein the recipient list includes a plurality of recipient email addresses.

4. The system of claim 1, wherein the multimedia retrieval email message includes multimedia retrieval information that is described in an extensible markup language.

5. The system of claim 1, wherein the multimedia module is to stream the multimedia content message, over the network.

6. The system of claim 5, wherein the multimedia module is to communicate the multimedia content message to a mail module that includes a multimedia mail module plugin.

7. The system of claim 1, wherein the multimedia module is to communicate the multimedia content message to a multimedia mail module.

8. The system of claim 1, wherein the receiving module is to receive a request to initiate the streaming.

9. The system of claim 8, wherein the receiving module is to utilize a real time messaging protocol to receive the request.

10. A method comprising:
receiving a streamed multimedia content message;
storing the streamed multimedia content message in a multimedia content file;
receiving a recipient list that includes an email address of a first recipient;
generating a multimedia retrieval email message that includes a multimedia content message identifier that identifies the multimedia content file, the generating of the multimedia retrieval email message being responsive to the receiving of the recipient list; and
communicating the multimedia retrieval email message, over a network, to the email address of the first recipient, the multimedia content message identifier of the multimedia retrieval email message being selectable to enable streaming of the multimedia content file, over the network, to the first recipient.

11. The method of claim 10, further comprising receiving a request to initiate the streaming.

12. The method of claim 11, further comprising streaming the multimedia content message, over the network, responsive to receiving the request.

13. The method of claim 11, wherein the receiving of the request includes utilizing a real time messaging protocol.

14. (canceled)

15. The method of claim 10, wherein the received recipient list includes a plurality of email addresses for a plurality of recipients, and the generating of the multimedia retrieval email message includes generating a plurality of multimedia retrieval email messages, one multimedia retrieval email message per email address included in the recipient list.

16. The method of claim 10, wherein the storing of the multimedia content message includes identifying an inbox that is associated with the first recipient.

17. The method of claim 10, further including receiving a multimedia metadata message.

18. The method of claim 17, wherein the multimedia metadata message includes a stream name to identify the multimedia content message.

19. The method of claim 10, wherein the multimedia content message includes video data and audio data.

20. A tangible machine-readable medium storing a set of instructions that, when executed by a machine, cause the machine to:
receive a stream that includes a multimedia content message;
store the stream in a multimedia content file;
receive a recipient list that includes an email address of a first recipient;
generate a multimedia retrieval email message that includes a stream identifier that identifies the stream; and
communicate the multimedia retrieval email message, over a network, to an email address of the first recipient, the multimedia retrieval email message to enable a selection of the stream identifier to initiate a stream of the multimedia content message, over the network, to the first recipient.

21. A system comprising:
a first means to receive a stream that includes a multimedia content message and receive a recipient list that includes an email address of a first recipient, the stream received over a persistent connection between a client machine and the first means; and
a second means to store the stream in a multimedia content file, the second means to generate a multimedia retrieval email message that includes a stream identifier that identifies the stream, the second means to communicate the multimedia retrieval email message, over a network, to the first recipient, the multimedia retrieval email message to enable a selection of the stream identifier to initiate a stream of the multimedia content file, over the network, to the first recipient.
